(19) United States
(12) Patent Application Publication
(10) Pub. No.: US 2004/0173243 A1
(43) Pub. Date: Sep. 9, 2004

(54) Mobile unit for cleaning electrolytic cells

(76) Inventors: Francisco Gaston Bossel Igor, Santiago (CL); Juan Ignacio Villegas Bozzo, Santiago (CL); Pablo Agustin Baffico Colombo, Santiago (CL)

Correspondence Address: BIRCH STEWART KOLASCH & BIRCH, PO BOX 747, FALLS CHURCH, VA, 22040-0747, US

(21) Appl. No.: 10/726,523

(22) Filed: Dec. 4, 2003

(30) Foreign Application Priority Data
Dec. 5, 2002 (CL) 2806-2002

(51) Int. Cl. B08B 3/02

(52) U.S. Cl. 134/18; 134/1; 134/21; 134/34; 15/321; 15/320

(57) ABSTRACT

An autonomous mobile unit for cleaning electrolytic cells is disclosed that includes a suction manifold, a pumping system, a solids-liquids separator, a recirculation manifold, a solids retainer and a control system that, when used, permits the cleaning of the electrolytic cells without the need to short-circuit the cells. A method of using the unit is also disclosed.

### SUMMARY

This invention corresponds to a process for cleaning anodic sludge from the electrowinning cell without the need to short-circuit the cell, using a completely autonomous mobile unit that is able to suction the slurries from the bottom of the cell, separate the solids present and return the electrolytic solution to the same cell, while the cell continues its electro-deposition process.

### SPECIFICATION

This invention refers to a procedure and to specific components to be used in the electrolytic processes for obtaining copper that through the accumulation of an electrolytic solution in electrowinning cells implies, by accumulation of lead oxide in the anodes, the sedimentation of solids in suspension, producing anodic sludge in the lower part of these electrolytic cells.

As the electrolytic solution flows within the cell, the accumulation of anodic sludge increases, generating:

loss of capacity of the electrowinning cells;

contamination of the solution due to resuspension of sedimented solids as a result of turbulences produced by the inflow to the cell;

contamination of cathodes present in the electrowinning cells as a result of the resuspension of the deposited solids due to turbulences produced by the inflow to the tank or by a simple increase in the level of the anodic sludge accumulated in the lower part of the tank.

At present, to overcome the inconvenience that said accumulations cause, the mechanisms for cleaning the anodic sludge accumulated at the bottom of the electrowinning cells are based on:

removal of the electrowinning cell from the production cycle by means of a short-circuiting frame;

cutting the inflow of electrolytic solution to the cell;

removal of the cathodes and anodes present in the cell;

emptying or purging the cell's electrolyte solution by means of pumping systems or, if possible, by means of valves located in the lower part of the cell; and

dissolving of the solid sediment by washing and subsequently removing the anodic sludge, either by emptying the resulting solution by means of the purge valve located in the bottom of the cell or else through the collection of the anodic sludge by means of a mechanical solids or sludge recollection device.

The above-described mechanism is very costly for the mining industry, as it includes loss of production capacity, detaining of the process and contamination of cathodes as a result of the sedimented sludge.

Therefore, the mentioned invention achieves the removal of the anodic sludge accumulated at the bottom of the electrolytic cells of copper electrowinning processes by means of a mobile and autonomous unit, without the need to execute forced shutdowns of the productive cycles eliminating from the productive process the current mechanism for removal of anodic sludge via the procedure and the components indicated below:

In the first place, before cleaning the cell, the process of this invention requires the removal of one of the three lingadas or groups of cathodes present by means of the current removal mechanism (traveling crane). The mobile unit must be located within a perimeter of between 1 and 15 meters from the cell, energized by electricity with a 380-volt line of force. Once the unit is turned on, the anodic sludge produced by the sedimentation of solids in suspension is removed from the bottom of the cell by means of a component named suction manifold (1) that the operator(s) of the mobile unit must introduce partially into the electrowinning cell in the spaces produced by the removal of the group of cathodes. When the nozzle of the suction manifold (1) reaches the sludge, the operator(s) must move the nozzle of the suction manifold (1) slowly in a direction parallel to the position of the anodes, trying to cover the entire suction area covered by the nozzle. This operation must be repeated in each space produced by the removal of the load of cathodes, until the entire area of the bottom of the cell that is being cleaned has been covered. As the sludge is suctioned by the suction manifold (1), a pumping system (2) feeds a solids-liquids separator (3), where the solids in suspension are retained and the filtered electrolytic solution is returned to the cell's purge overflow by means of a recirculation manifold (4), thus permitting the cell to continue electro-depositing without altering either the level or the chemical quality of the electrolytic solution. Once the solids retained in the solids-liquids separator (3) have saturated it, the operator(s) of the unit must remove the solids, therefore the process must be interrupted. Then, the solids that have been retained are removed with scrapers and the pull of gravity causes them to drop into the solids collector (5) that, once full, is removed to place the solids in an intermediate disposal site provided by the mining company. In this way, the electrowinning cell can be cleaned completely without the need to recur to the current cleaning mechanism that necessarily implies the stopping of the productive process.

The component named suction manifold (1) consists of a nozzle made of an elastomeric material, measuring between 100 and 800 mm in length with an opening of between 1 to 1000 square centimeters that allows it to cover the entire area of the bottom of the electrowinning cell without having to remove the groups of cathodes from the cell and with the advantage that it does not cause the sludge to reenter the electrolyte solution. This nozzle is held by means of a thermal retaining mechanism (plastic polypropylene welding), a rigid suction tube of between 0.5 and 3 meters long, designed with a diameter slightly inferior to the space between one anode and another in the electrowinning cell; and manufactured of polymeric material. The rigid suction tube is linked by means of a fast plastic coupling to a flexible hose having exactly the same interior diameter as the tube. The length of the hose varies between 1 and 15 meters, and its material is of heat-resistant ductile plastic (up to 70 degrees Celsius). The suction power of the manifold (1) is given by the suction line of the pumping system (2).

On its part, the function of the pumping system (2) will provide the driving force to suction and transport the sludge in suspension along with the electrolyte solution, through the suction manifold (1) toward the solids-liquids separator system (3) and deliver sufficient pressure to this system (between 2 and 16 Bar) to permit the separation of the solids. The pumping system (2) consists of a peristaltic pump, with a capacity of flow between 1 and 30 cubic meters per hour, where the flexible hose of the suction manifold (1) is coupled to the pump's suction line, by means of a sealed retaining flange. The suction line of this type of pump attains a negative suction power of between 1 and 9 meters water column, which permits the removal of the anodic sludge from the bottom of the cell by the suction manifold (1). The pump's discharge line is coupled, also by means of a sealed retaining flange, to a flexible rubber hose that is heat and high pressure resistant and which, in turn, is joined in the same way to a stainless steel piping 316 L of exactly the same interior diameter as the rubber hose that feeds the solids-liquids separator (3). The flexible rubber hose makes it possible to transport the solids dissolved in the electrolytic solution, resisting the hydraulic pressure exercised by the Separator against the pump's discharge. The purpose of the stainless steel piping is not only to resist the pressure but also to sustain in the hydraulic line of flow all the elements of control of the control system (6), translated to a pressure gage with ranges from 0 to 20 Bar and an electrically controlled pressure switch. The pumping system (2) feeds the solids-liquids separator (3) anticipating the hydraulic pressure needed to produce the separation.

The solids-liquids separator (3) permits the semi-continuous separation of the solids contained in the electrolytic solution. The solids-liquids separator (3) consists of a press filter made up of polypropylene plates fed by the stainless steel piping of the pumping system (2), connected by a retaining flange in the filter's head plate. The capacity of the filtering element may vary between 30 and 2500 liters, and the result of this variation is plate formats of between 470 up to 1500 lateral millimeters. Nylon or polypropylene cloth is used as the filtering means between the plates of the press filter, whose characteristics vary between woven and non-woven, calendared and non-calendared, with the possibility of using heat-set cloth. As the plate filter starts to retain the solids of the anodic sludge in suspension, the filtered electrolyte solution is collected continuously by the recirculation manifold (4).

Additionally, the component named recirculation manifold (4) consists of a polymeric flexible hose of between 1 to 10 meters in length, that ends in a circular plastic nozzle having a diameter of 10 to 120 millimeters that is introduced freely into the overflow purged from the cell. Upon reaching pressures between 2 and 16 Bar, the press filter must be opened; therefore the process is detained. In this way the solids retained in the filtering cloths are removed from the plates of the press filter using scrapers and drop by gravity into the solids collector (5) that consists of a rectangular container with a volume between 30 and 2500 liters, manufactured of an elastomeric material, preferably polypropylene, with a length slightly greater than the length of the filtering package of the press filter.

On its part, the control system (6) commands the unit, establishing the safety and electric feed mechanisms. This system consists of a visual manometer installed in the stainless steel piping 316 L of the pumping system (2) together with an electrically controlled pressure switch controlled for cutoff between 2 and 16 Bar that controls the functioning of the pump of the pumping system (2) from a switchboard. The entire unit is autonomous and will function correctly once the control panel has been energized electrically.

In its preferred application, the invention is designed for the cleaning of cells in the copper electrowinning processes. Nevertheless, the system can be used in the same way in the electrowinning of other metals such as Zinc or in the copper electro-refining processes and other analogous applications.

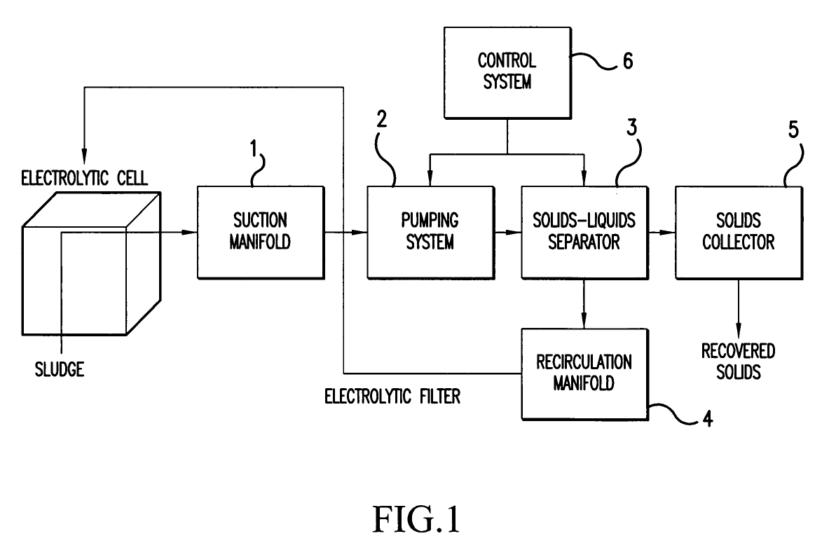

The flow chart in FIG. 1 describes the system or process for cleaning an electrolytic cell and its components that are the suction manifold (1), pumping system (2), solids-liquids separator (3), recirculation manifold (4), solids collector (5), and control system (6).

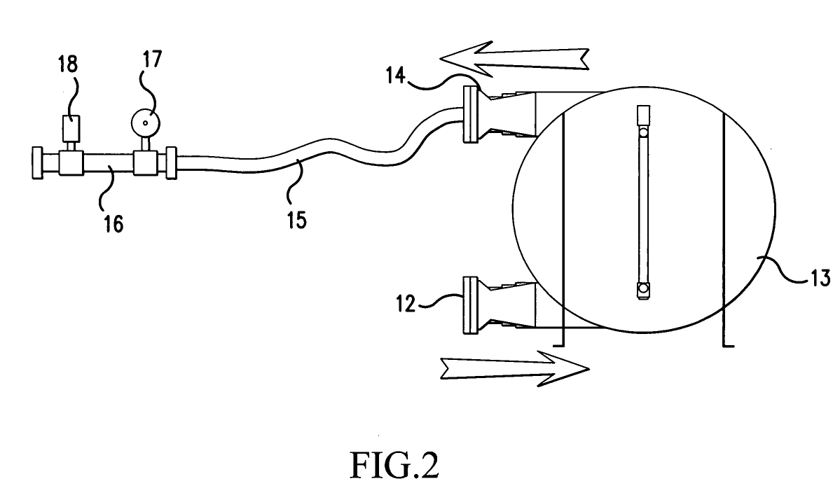

FIG. 2 describes the pumping system that will provide the driving force to suction and transport the sludge in suspension along with the electrolyte solution, through the suction manifold (1) toward the solids-liquids separator system (3) and that will deliver sufficient pressure to this system (between 2 and 16 Bar) to permit the separation of the solids. The pumping system (2) consists of a peristaltic pump, with a capacity of flow between 1 and 30 cubic meters per hour, where the flexible hose of the suction manifold (1) is attached to the pump's suction line by means of a sealed retaining flange. The suction line of this type of pump manages to achieve a negative suction power between 1 and 9 meters water column, which permits the removal of the anodic sludge from the bottom of the cell through the suction manifold (1). The pump's discharge line is attached, also by means of a sealed retaining flange, to a flexible rubber hose that is heat and high pressure resistant, which in turn is joined in the same way to a stainless steel piping 316 L having exactly the same interior diameter as the rubber hose that feeds the solids-liquids separator (3). The flexible rubber hose permits the transportation of the solids dissolved in the electrolytic solution, resisting the hydraulic pressure exercised by the Separator against the discharge from the pump. The purpose of the stainless steel piping is not only to resist the pressure but also to sustain in the hydraulic line of flow all the elements of flow of the control system (6), translated to a pressure gage with ranges of 0 to 20 Bar and an electrically controlled pressure switch. The pumping system (2) feeds the solids-liquids separator (3) anticipating the hydraulic pressure needed to produce the separation.

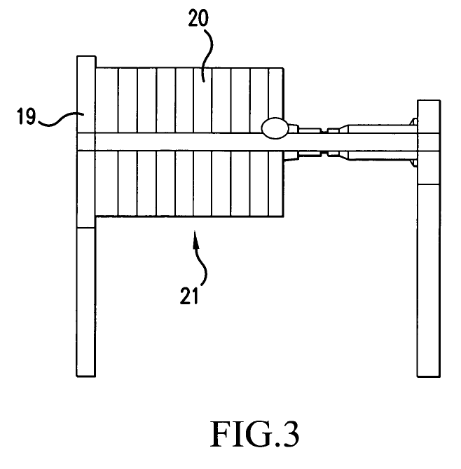

FIG. 3 describes the solids-liquids separator that permits the semi-continuous separation of the solids contained in the electrolytic solution. The solids-liquids separator consists of a press filter made up of polypropylene filtering plates fed by the stainless steel piping of the pumping system, joined by a retaining flange in the filter's head plate.

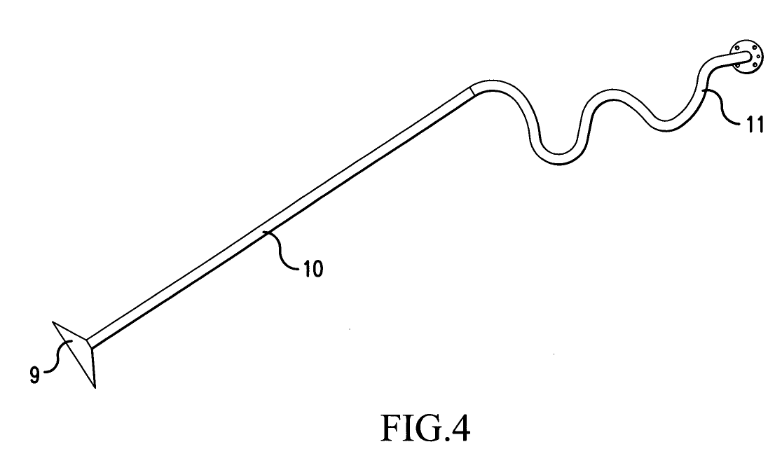

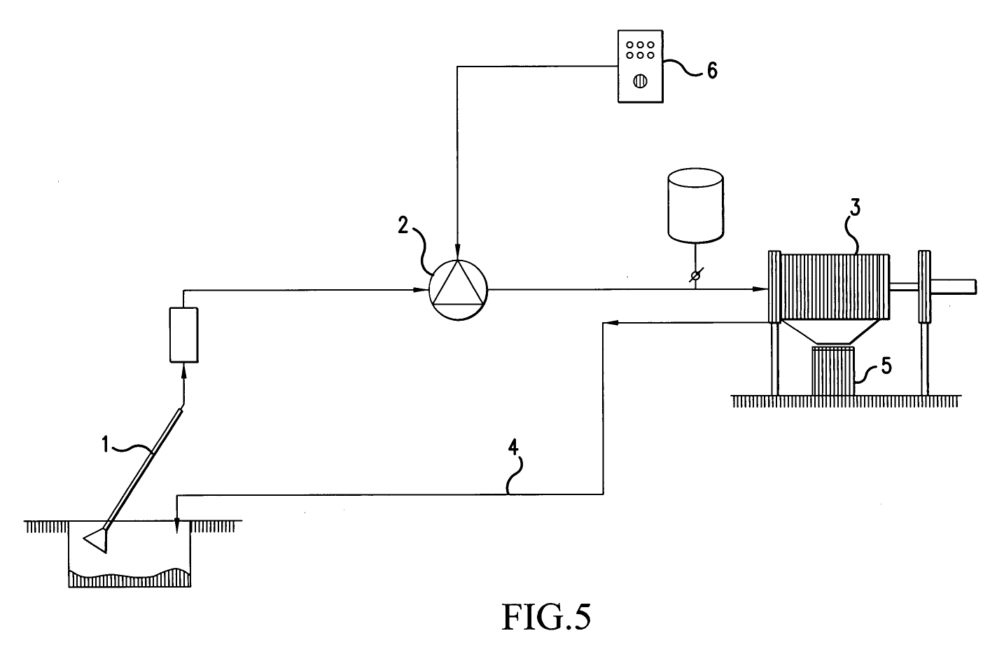

FIG. 4 describes the suction manifold that consists of a nozzle of elastomeric material, with a length between 100 and 800 millimeters, with an opening between 1 and 1,000 square centimeters that allows it to cover the entire area of the bottom of the electrowinning cell without needing to remove all the groups of cathodes from the cell and with the advantage of not causing the sludge to reenter the electrolytic solution. This nozzle is held by means of a thermal retaining mechanism (plastic welding of polypropylene) to a rigid suction tube having a length between 0.5 and 3 meters, designed with a diameter slightly smaller than the space between one anode and another in the electrowinning cell; and manufactured of polymeric material. The rigid suction tube is joined by means of a fast plastic coupling to a flexible hose that has exactly the same interior diameter as the tube. The length of the hose varies between 1 and 15 meters, and its material is heat-resisting ductile plastic (up to 70 degrees Celsius). The suction power of the manifold (1) is provided by the suction line of the pumping system (2).

1. An autonomous mobile unit for cleaning electrolytic cells CHARACTERIZED because it includes a system or process and diverse components that include a suction manifold, a pumping system, a solids-liquids separator, a recirculation manifold, a solids retainer and a control system that when used permits the cleaning of the electrolytic cells without the need to short-circuit the cell.

2. A mobile unit according to claim 1, CHARACTERIZED by a pumping system made up of: a diaphragm pump, a screw pump, a centrifugal pump, an electric diaphragm pump, a vacuum pump, a submergible pump and a peristaltic pump.

3. A mobile unit according to claim 1, CHARACTERIZED by a solids-liquids separator made up of the following equipment: a plate filter press, a band filter press, a hydrocyclone, a centrifuge or decanter, a bag filter, a rotary filter and an online filter screen.

4. A mobile unit according to claim 3, CHARACTERIZED by a stainless steel piping in the pump's discharge line and polypropylene piping in the pump's discharge lie.

5. A process for cleaning electrolytic cells using the system and the components of any of claims 1 to 4 inclusive in different stages of application CHARACTERIZED because it avoids the stages of cleaning the anodic sludge accumulated in the bottom of the electrolytic cells that are based on the removal from the electrowinning cells of the production cycle using a short-circuiting frame; cutting off the flow of the electrolytic solution that is fed into the cell; removal of the cathodes and anodes present in the cell; emptying or purging of the electrolyte solution from the cell by means of pumping systems or, if possible, by means of valves located in the lower part of the cell; and the dissolving of the sedimented solids by means of washing the anodic sludge and its subsequent removal, either by emptying the resulting solution by means of the purge valve located at the bottom of the cell or else by gathering the anodic sludge by means of a mechanical device for collecting solids or sludge.
